(19) United States
(12) Patent Application Publication
(10) Pub. No.: US 2026/0098514 A1
(43) Pub. Date: Apr. 9, 2026

(54) River Paddle Wheel Generator Device

(71) Applicant: Matthew Shun, Glendale, CA (US)

(72) Inventor: Matthew Shun, Glendale, CA (US)

(21) Appl. No.: 18/959,964

(22) Filed: Nov. 26, 2024

Related U.S. Application Data
(60) Provisional application No. 63/703,278, filed on Oct. 4, 2024.

(51) Int. Cl. F03B 17/06; B63B 35/28

(52) U.S. Cl. CPC F03B 17/063; B63B 35/28

(57) ABSTRACT

A river paddle wheel generator device is disclosed, wherein the device uses river currents to rotate paddle wheels and generate electricity without using fossil fuel. The river paddle wheel generator device comprises a river barge anchored in a riverbed with a flat deck and multiple generators attached. Multiple paddle wheels are designed to hang over the sides of the barge in the water. The river current rotates the paddle wheels which then turns the electric generator and creates renewable electricity.

### CROSS-REFERENCE TO RELATED APPLICATION

The present application claims priority to, and the benefit of, U.S. Provisional Application No. 63/703,278, which was filed on Oct. 4, 2024, and is incorporated herein by reference in its entirety.

### FIELD OF THE INVENTION

The present invention relates generally to the field of river paddle wheel generator devices. More specifically, the present invention relates to a river barge unit equipped with paddles and generators that create electricity via the river's current. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in river paddle wheel generator devices. Generally, non-renewable fossil fuels, such as oil, gas, and coal, come with several significant issues that affect both the environment and society. The combustion of fossil fuels releases large amounts of carbon dioxide and other greenhouse gases like methane into the atmosphere. These emissions are a major contributor to global warming and climate change, leading to rising temperatures, melting polar ice, and more frequent extreme weather events. These issues also raise concerns about the long-term sustainability of relying on these energy sources, especially as global demand continues to grow.

With the energy needs of society growing each year, efforts to obtain the maximum benefit from conventional and alternative sources has intensified in recent years. Technology and capital are being harnessed and allocated to search for new energy sources that range from deep-water oil drilling off the continental shelves to hydrogen fusion and from windmills to natural gas. Hydroelectric power (i.e., wherein waterpower is used in the generation of electricity) is also being employed as most notably attested to by the Three River Gorges dam in China. The device prevents new dams being created related to power generation. However, hydroelectric power generation doesn't have to be limited to locations astride the major rivers of the world. Numerous geographic locales include swiftly running or hard running streams that if properly utilized could provide the power needs—at low cost or no cost—to small villages and towns and to rural areas that may be otherwise hard to service. The hydroelectric power generation devices that would utilize narrow, hard running streams as the source of electric generation would need to be easy to transport and set up, relatively simple in construction and operation, and generally low maintenance.

Accordingly, there is a demand for an improved river paddle wheel generator device that uses paddles and generators that work in conjunction to generate and store power. More particularly, there is a demand for a river paddle wheel generator device that offers an environmentally friendly method of creating electricity for homes and businesses.

Therefore, there exists a long-felt need in the art for a river paddle wheel generator device that provides users with a river barge unit equipped with paddles and generators that create electricity via the river's current. There is also a long-felt need in the art for a river paddle wheel generator device that allows electric companies to anchor the barges into the riverbed and utilize the flowing current to generate renewable power. Further, there is a long-felt need in the art for a river paddle wheel generator device that features multiple paddles and generators that work in conjunction to generate and store power. Moreover, there is a long-felt need in the art for a device that offers an environmentally friendly method of creating electricity for homes, businesses, and more. Further, there is a long-felt need in the art for a river paddle wheel generator device that provides covered generators to withstand inclement weather and constant water flow from the river current. Finally, there is a long-felt need in the art for a river paddle wheel generator device that allows electrical companies to utilize several of these devices to generate renewable energy for customers.

The subject matter disclosed and claimed herein, in one embodiment thereof, comprises a river paddle wheel generator device. The device uses river currents to rotate paddle wheels and generate electricity without using fossil fuel. The river paddle wheel generator device comprises a river barge anchored in a riverbed with a flat deck and multiple generators attached. Multiple paddle wheels are designed to hang over the sides of the barge in the water. The river current rotates the paddle wheels which then turns the electric generator and creates renewable electricity. The barge is typically steel and supports the generators, which are similar to those used by windmills, and which are covered on the barge to withstand inclement weather and constant water flow from the river current. Electrical companies can utilize several of these barges to generate renewable energy for customers.

In this manner, the river paddle wheel generator device of the present invention accomplishes all of the foregoing objectives and provides users with paddles and generators that work in conjunction to generate and store power. The device is a barge with a generator and paddle wheel that is anchored in a riverbed. The device can comprise multiple barges tied together.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a river paddle wheel generator device. The device uses river currents to rotate paddle wheels and generate electricity without using fossil fuel. The river paddle wheel generator device comprises a river barge anchored in a riverbed with a flat deck and multiple generators attached. Multiple paddle wheels are designed to hang over the sides of the barge in the water. The river current rotates the paddle wheels which then turns the electric generator and creates renewable electricity.

In one embodiment, the river paddle wheel generator device features a floating electrical power generation system for deployment in flowing streams, rivers, and other such bodies of water. The term river or stream is used hereinafter to describe any suitable body of water in which the river paddle wheel generator device can be successfully operated. Further, multiple river paddle wheel generator devices can be employed in one area and tied together to generate additional electricity or used independently, depending on a user's needs and/or wants.

In one embodiment, the river paddle wheel generator device comprises a river barge or other flat-bottomed vessel for carrying freight. The river barge typically does not have its own means of mechanical propulsion. Typically, the river barge must be pulled by tugs or pushed by pusher boats or other vessels until it reaches its destination. A typical American barge measures approximately 195 by 35 feet (59.4 m×10.7 m) and can carry up to about 1,500 short tons (1,400 t) of cargo. The river barge comprises a top surface, a bottom surface, bow and stern sides, and opposing sidewalls. Further, the top surface comprises a flat deck for easy transport of the cargo, with typically the entire top surface of the deck being flat. While a barge-style vessel has been chosen for purposes of disclosure, it will be recognized that other vessel styles and types may also be used to implement the river paddle wheel generator device. Consequently, the invention is not considered limited to any particular vessel style or type but covers any and all suitable vessel types.

In one embodiment, the river barge comprises multiple paddle wheels. Multiple paddle wheels are supported on a central shaft, disposed between the top surface of the barge. Generally, there are multiple paddle wheels associated with each generator. Further, the central shaft is supported in bearing housings. Typically, the central shaft has a pulley, bull gear, or other suitable power take off affixed thereto. Further, each of the paddle wheels includes spaced apart cylindrical support plates that are also concentric to the central shaft and mounted in between, and to the support plates are a plurality of dip blades or vanes. The dip blades or vanes are spaced from each other and are radially arranged about the cylindrical support plates. A major portion of each dip blade laterally projects past the peripheral edge of each support plate thereby assuring their continual contact with the flowing riverbed and the continual rotation of the paddle wheel by the water current. The spacing of the dip blades is such that at least three dip blades are always in contact with the flowing riverbed assuring the continuous rotation of the paddle wheel. Mounted to the exterior of one cylindrical support plate, and contiguous thereto, is a circular main drive gear. The main drive gear is also concentrically mounted to the central shaft. The main drive gear rotates concomitant with the rotation of the central shaft as a result of the water current continually turning the dip blades of the paddle wheel. A cylindrical shaft cap is mounted on the central shaft and maintains the position of the main drive gear contiguous to the cylindrical support plate and prevents any axial movement of the main drive gear on the central shaft.

In one embodiment, a transmission or gearbox is mounted adjacent multiple paddle wheels and is operatively connected to the power take off by a suitable power transfer arrangement. Such a power transfer arrangement may be one or more V-belts, poly V-belts, cog belts, a gear train, or any other suitable arrangement whereby rotary motion at power take off is transferred to an input of transmission or gearbox. Such coupling arrangements are known to those of skill in the rotating machinery arts and are not further described herein. The invention is not considered limited to the V-belt drive chosen for purposes of disclosure. Rather, the invention encompasses any and all suitable power transfer mechanisms.

In one embodiment, the river barge also comprises one or more generators which are connected to the transmission or gearbox by a second power transfer arrangement, which can be any suitable mechanism including, but not limited to, V-belts, poly V-belts, cog belts, or a gear train, etc., which may be used to perform the necessary power transfer function by cycle like chain drives and related gears. Other arrangements can include paddles arranged further outboard of the paddles closest to the hull. Typically, there are two generators per river barge, but any suitable number of generators can be utilized as is known in the art. Accordingly, the paddle wheels are configured to rotate and the rotational motion of the paddle wheel is used for rotating the generator which generates electricity. The generator and the paddle wheel are connected through the central shaft. Specifically, the generator is configured to produce electric energy using the mechanical energy of the paddle wheel. The efficiency of the generator is dependent on the mechanical energy produced by the rotation of the paddle wheel. Thus, the river current rotates the paddle wheels, which then turns the electric generator and creates renewable electricity. The generator is used to represent any useful rotating machine which may be powered by application of rotary motion to an input thereof. It will be recognized that multiple generators may be driven by the transmission or gearbox using any suitable coupling arrangement.

In one embodiment, each paddle wheel transfers rotational energy to the generator to convert rotational energy into electricity; an electronic controller to monitor the paddle wheels; and brakes to stop the central shaft rotation in case of overload and or device failure.

In one embodiment, mooring attachment points are typically disposed near the forward port and starboard corners of the flat deck of the top surface and are adapted for attachment of a mooring cable, rods, or rope to anchor the device in a riverbed. Other forms of anchoring can be utilized with proper authorization of the devices including “spuds”.

In one embodiment, a debris guard is disposed at the forward edge of the flat deck of the top surface. It will be recognized that other arrangements may be provided to prevent water-borne debris from jamming or injuring the paddle wheels. Further, the invention is not considered limited to the particular debris guard arrangement chosen for purposes of disclosure. It will further be recognized that additional debris guards not mechanically affixed to the river barge may also be placed upstream therefrom when required.

In one embodiment, the generators include a weatherproof housing or covering to protect the generators from inclement weather and/or spray from the stream or river, as well as the constant water flow from the river current. In addition, the housing or covering is useful for protecting the generators from vandalism or other unauthorized access. The housing or covering may be made from fiberglass, aluminum, or other thermoplastic resins or metals. The housing or covering may be attached directly to the flat deck using any suitable attachment means, not shown. In alternate embodiments, the housing or covering may be hingedly attached to the generator or to the flat deck. One or more suitable locks, not shown, may be provided to prevent unauthorized removal of the housing or covering from the generator or from the flat deck of the top surface.

In one embodiment, the river barge can comprise legs provided, typically around the periphery of the bottom surface. The legs have a minimum length extending below the barge and also corresponding to the radius of the multiple paddle wheels projecting beneath the top surface of the barge. The legs have several functions, notably to prevent the bottoming of the paddle wheels during periods of low water. In addition, the legs are potentially useful during the construction of the device and/or for dry docking the device during winter months. Legs may be rigidly or slidably and adjustably attached to the bottom surface of the barge using mounting or height-adjusting mechanisms known to those skilled in the art. Typically, at least four legs are provided. Legs are typically disposed near the four corners of the bottom surface of the barge. It will be recognized that other numbers of legs may be chosen to meet a particular operating circumstance or environment. Consequently, the invention is not considered limited to any particular number, style, attachment point, or attachment modality of legs but covers any number of legs attached to the barge in any manner.

In one embodiment, if the river paddle wheel generator device is to be used in navigable waters, it is imperative that appropriate navigational lights be provided in accordance with United States Coast Guard regulations, local regulations, or any other authority having such a requirement. Lights may be disposed on masts or directly attached to the flat deck, as required, or to the paddle wheels, etc. The selection and placement of navigational lights for watercraft is well known to those of skill in the art and is not further described herein.

In one embodiment, there are three river paddle wheel generator devices supported on three floating barges that are spaced from each other across the width of the riverbed. The spacing of the barges creates channels that enhance the flow of water flowing therebetween, and thus the paddle wheels turn with greater rapidity because of the increased flow velocity of the water. Typically, the barges are anchored into the riverbed or tethered to posts or stanchions on the riverbanks by flexible cables. The flexible cables allow the floating barges some slack to accommodate changing river levels and changing river currents. The multiple generators are in communication to accumulate electricity for distribution to the electrical grid system or stored in batteries. Any suitable number of river paddle wheel generator devices can be utilized together to generate electricity. For example, electrical companies can utilize several of these barges to generate renewable energy for their customers.

In operation, the river paddle wheel generator device may be constructed in a dry dock where the legs elevate the multiple paddle wheels above a deck or other surface. When desired, the device may be placed into a flowing body of water and navigated to a desired location thereupon by a pusher boat or pulled by a tugboat, which is attached to the barge at mooring attachment points.

Once in position, cables, rods or ropes, or the like may be used to tether/anchor the device in the river or stream. Anchor blocks are typically used for mooring the barge in the riverbed for use. Anchor blocks and the like are well known to those of skill in the marine construction arts and are not further described herein. Further, mooring attachment points are typically provided at or near the outer corners of the flat deck to allow a two-point anchoring system to be used thereby optimizing alignment of the barge with the water current.

Furthermore, the multiple paddle wheels extend beneath the top surface of the barge and are rotated by the action of water against the blades thereof. The rotation of the paddle wheels turns the power take off device (i.e., a pulley or bull gear). Then, rotary motion of the power take off is transferred to an input of the transmission or gearbox by belts. The output of the transmission or gearbox is, likewise, coupled to the generator by a belt. Further, the transmission or gearbox is then used to manually, semi-automatically, or fully automatically control the rotational speed of the generator as water current conditions in the stream or river change. Such control of the transmission or gearbox is well understood by those of skill in the art; a more complete description of the operation thereof is not included herein. As previously stated, the transmission or gearbox may be a gearless transmission using one or more conical pulleys to maintain a substantially constant speed of the generator regardless of the rotational speed of the paddle wheels. Electrical power produced from the generator may be used to charge an on-vessel battery or batteries to power navigational lights, etc. A step-up transformer, not shown, may raise the generator voltage to minimize transmission losses to shore. Further, power transmission to shore may be by an underwater or an overhead cable, not shown. In another embodiment, an electrical main or cable extends outwardly through the central shaft and from the generator for interconnection to the existing electrical grid system in the region or locale for which the river paddle wheel generator device has been set up so that electricity is continuously supplied to the grid system.

In one embodiment, the barge is manufactured from steel, aluminum, plastic, fiber-reinforced plastic, or other suitable materials as is known in the art, or a combination of such materials.

In yet another embodiment, the river paddle wheel generator device comprises a plurality of indicia.

In yet another embodiment, a method of generating energy via river currents is disclosed. The method includes the steps of providing a river paddle wheel generator device comprising a river barge with multiple generators and multiple paddle wheels. The method also comprises transporting the barge to a riverbed. Further, the method comprises anchoring the barge within the riverbed. The method also comprises allowing water to flow around the barge to turn the paddle wheels. Finally, the method comprises harnessing energy from the rotation of the paddle wheels to generate electricity.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the river paddle wheel generator device of the present invention showing the device anchored in a riverbed in accordance with the disclosed architecture;

FIG. 2 illustrates a perspective view of one embodiment of the river paddle wheel generator device of the present invention showing how the device is anchored in a riverbed in accordance with the disclosed architecture;

FIG. 3 illustrates a perspective view of one embodiment of the river paddle wheel generator device of the present invention showing the barge floating in the river in accordance with the disclosed architecture;

FIG. 4 illustrates a perspective view of one embodiment of the river paddle wheel generator device of the present invention showing how water flow turns the paddle wheels in accordance with the disclosed architecture;

FIG. 5 illustrates a perspective view of one embodiment of the river paddle wheel generator device of the present invention showing the device in use generating energy in accordance with the disclosed architecture; and

FIG. 6 illustrates a flowchart showing the method of generating energy via river currents in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a river paddle wheel generator device that provides users with a river barge unit equipped with paddles and generators that create electricity via the river's current. There is also a long-felt need in the art for a river paddle wheel generator device that allows electric companies to anchor the barges into the riverbed and utilize the flowing current to generate renewable power. Further, there is a long-felt need in the art for a river paddle wheel generator device that features multiple paddles and generators that work in conjunction to generate and store power. Moreover, there is a long-felt need in the art for a device that offers an environmentally friendly method of creating electricity for homes, businesses, and more. Further, there is a long-felt need in the art for a river paddle wheel generator device that provides covered generators to withstand inclement weather and constant water flow from the river current. Finally, there is a long-felt need in the art for a river paddle wheel generator device that allows electrical companies to utilize several of these devices to generate renewable energy for customers.

The present invention, in one exemplary embodiment, is a novel river paddle wheel generator device. The device uses river currents to rotate paddle wheels and generate electricity without using fossil fuel. The river paddle wheel generator device comprises a river barge anchored in a riverbed with a flat deck and multiple generators attached. Multiple paddle wheels are designed to hang over the sides of the barge in the water. The river current rotates the paddle wheels which then turns the electric generator and creates renewable electricity. Generating barge or other vessel may be coupled with other generating barges or vessels and used to power an electric motor driven tugboat or ship. The present invention also includes a novel method of generating energy via river currents. The method includes the steps of providing a river paddle wheel generator device comprising a river barge with multiple generators and multiple paddle wheels. The method also comprises transporting the barge to a riverbed. Further, the method comprises anchoring the barge within the riverbed. The method also comprises allowing water to flow around the barge to turn the paddle wheels. Finally, the method comprises harnessing energy from the rotation of the paddle wheels to generate electricity.

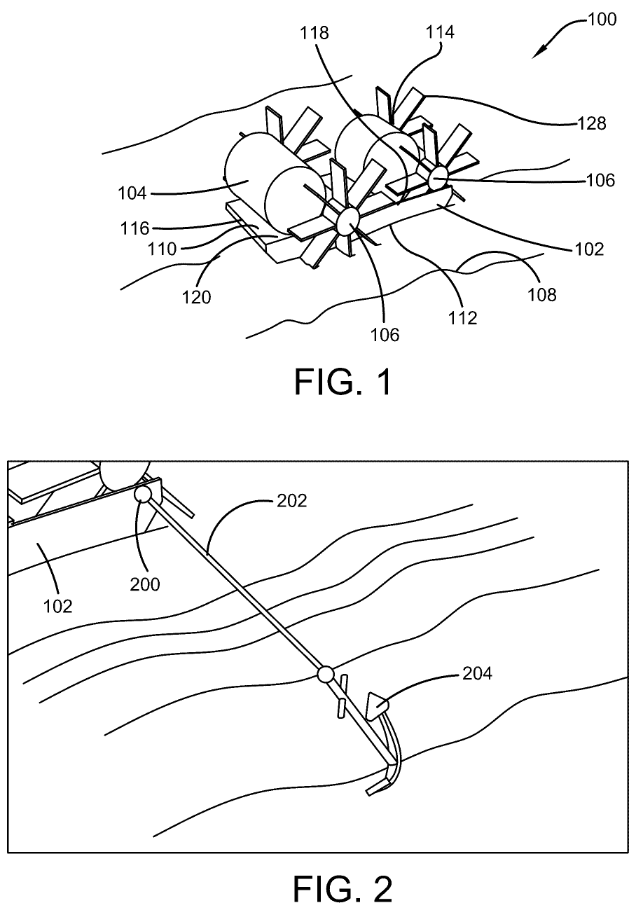

Referring initially to the drawings, FIG. 1 illustrates a perspective view of one embodiment of the river paddle wheel generator device 100 of the present invention. In the present embodiment, the river paddle wheel generator device 100 is an improved river paddle wheel generator device 100 that provides a user with a means for generating electricity via a river's current 108. The device 100 uses river currents 108 to rotate paddle wheels 106 and generate electricity without using fossil fuel. Specifically, the river paddle wheel generator device 100 comprises a river barge 102 with multiple generators 104 and multiple paddle wheels 106 attached. The river current 108 rotates the paddle wheels 106 which then turns the electric generator 104 and creates renewable electricity.

Generally, the river paddle wheel generator device 100 features a floating electrical power generation system for deployment in flowing streams, rivers, and other such bodies of water. The term river or stream is used hereinafter to describe any suitable body of water in which the river paddle wheel generator device 100 can be successfully operated. Further, multiple river paddle wheel generator devices 100 can be employed in one area and tied together to generate additional electricity or used independently, depending on a user's needs and/or wants.

Furthermore, the river paddle wheel generator device 100 comprises a river barge 102 or other flat-bottomed vessel for carrying freight. The river barge 102 typically does not have its own means of mechanical propulsion. Typically, the river barge 102 must be pulled by tugs or pushed by pusher boats or other vessels until it reaches its destination. A typical American barge measures approximately 195 by 35 feet (59.4 m×10.7 m) and can carry up to about 1,500 short tons (1,400 t) of cargo. The river barge 102 comprises a top surface 110, a bottom surface 112, bow 114 and stern 116 sides, and opposing sidewalls 118. Further, the top surface 110 comprises a flat deck 120 for easy transport of the cargo, with typically the entire top surface 110 of the deck 120 being flat. While a barge-style vessel has been chosen for purposes of disclosure, it will be recognized that other vessel styles and types may also be used to implement the river paddle wheel generator device 100. Consequently, the invention is not considered limited to any particular vessel style or type but covers any and all suitable vessel types.

Additionally, the river barge 102 comprises multiple paddle wheels 106. Multiple paddle wheels 106 are supported on a central shaft 122, disposed between the top surface 110 of the barge 102. Generally, there are multiple paddle wheels 106 associated with each generator 104. Further, the central shaft 122 is supported in bearing housings (not shown). Typically, the central shaft 122 has a pulley, bull gear, or other suitable power take off 124 affixed thereto. Further, multiple paddle wheels 106 include multiple spaced apart cylindrical support plates 126 that are also concentric to the central shaft 122 and mounted in between, and to the support plates 126 are a plurality of dip blades 128 or vanes. The dip blades 128 or vanes are spaced from each other and are radially arranged about the cylindrical support plates 126. A major portion of each dip blade 128 laterally projects past the peripheral edge of each support plate 126 thereby assuring their continual contact with the flowing riverbed and the continual rotation of the paddle wheel 106 by the water current 108. The spacing of the dip blades 128 is such that at least three dip blades 128 are always in contact with the flowing riverbed assuring the continuous rotation of the paddle wheel 106. Mounted to the exterior of one cylindrical support plate 126, and contiguous thereto, is a circular main drive gear or gearbox 130. The main drive gear 130 is also concentrically mounted to the central shaft 122. The main drive gear 130 rotates concomitant with the rotation of the central shaft 122 as a result of the water current 108 continually turning the dip blades 128 of the paddle wheel 106. A cylindrical shaft cap is mounted on the central shaft 122 and maintains the position of the main drive gear 130 contiguous to the cylindrical support plate 126 and prevents any axial movement of the main drive gear 130 on the central shaft 122.

Further, a transmission or gearbox 130 is mounted adjacent the multiple paddle wheels 106 and is operatively connected to the power take off 124 by a suitable power transfer arrangement 132. Such a power transfer arrangement 132 may be one or more V-belts, poly V-belts, cog belts, a gear train, or any other suitable arrangement whereby rotary motion at power take off 124 is transferred to an input of transmission or gearbox 130. Such coupling arrangements are known to those of skill in the rotating machinery arts and are not further described herein. The invention is not considered limited to the V-belt drive chosen for purposes of disclosure. Rather, the invention encompasses any and all suitable power transfer mechanisms.

Additionally, the river barge 102 also comprises one or more generators 104 which are connected to the transmission or gearbox 130 by a second power transfer arrangement 134, which can be any suitable mechanism including, but not limited to, V-belts, poly V-belts, cog belts, or a gear train, etc., which may be used to perform the necessary power transfer function. Typically, there are two generators 104 per river barge 102, but any suitable number of generators 104 can be utilized as is known in the art. Accordingly, the paddle wheels 106 are configured to rotate and the rotational motion of the paddle wheel 106 is used for rotating the generator 104 which generates electricity. The generator 104 and the paddle wheel 106 are connected through the central shaft 122. Specifically, the generator 104 is configured to produce electric energy using the mechanical energy of the paddle wheel 106. The efficiency of the generator 104 is dependent on the mechanical energy produced by the rotation of the paddle wheel 106. Thus, the river current 108 rotates the paddle wheels 106, which then turns the electric generator 104 and creates renewable electricity. The generator 104 is used to represent any useful rotating machine which may be powered by application of rotary motion to an input thereof. It will be recognized that multiple generators 104 may be driven by the transmission or gearbox 130 using any suitable coupling arrangement.

Further, each paddle wheel 106 transfers rotational energy to the generator 104 to convert rotational energy into electricity; an electronic controller 136 to monitor the paddle wheels 106; and brakes 138 to stop the central shaft 122 rotation in case of overload and or device 100 failure.

As shown in FIG. 2, mooring attachment points 200 are typically disposed near the forward port and starboard corners of the flat deck 120 of the top surface 110 and are adapted for attachment of a mooring cable, rods, or rope 202 to anchor the device 100 in a riverbed. Once the device 100 is in position, cables, rods or ropes 202, or the like may be used to tether/anchor the device 100 in the river or stream. Specifically, anchor blocks 204 are typically used for mooring the barge 102 in the riverbed for use. Anchor blocks 204 and the like are well known to those of skill in the marine construction arts and are not further described herein. Further, mooring attachment points 200 are typically provided at or near the outer corners of the flat deck 120 to allow a two-point anchoring system to be used thereby optimizing alignment of the barge 102 with the water current 108.

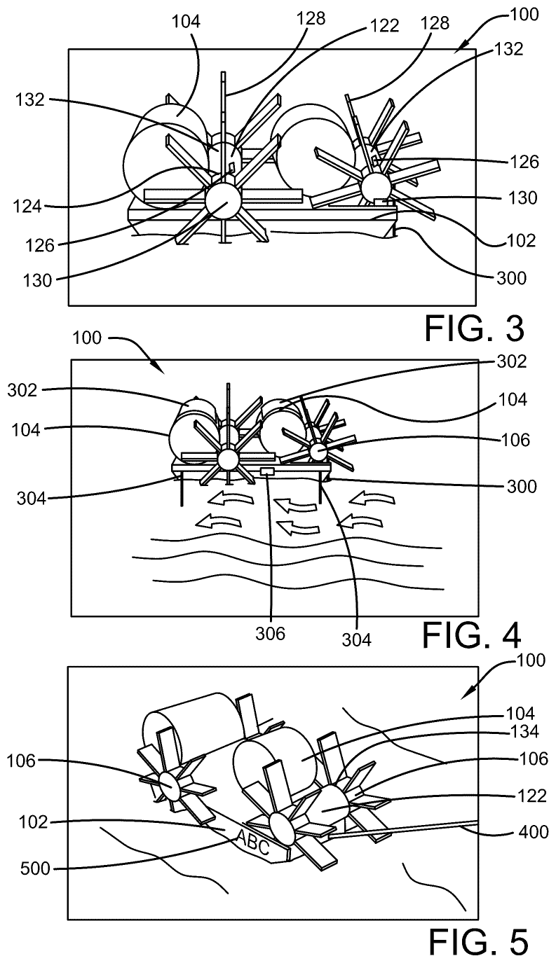

As shown in FIG. 3, in one embodiment, a debris guard 300 is disposed at the forward edge of the flat deck 120 of the top surface 110. It will be recognized that other arrangements may be provided to prevent water-borne debris from jamming or injuring the paddle wheels 106. Further, the invention is not considered limited to the particular debris guard arrangement chosen for purposes of disclosure. It will further be recognized that additional debris guards 300 not mechanically affixed to the river barge 102 may also be placed upstream therefrom when required.

Further, the generators 104 include a weatherproof housing or covering 302 to protect the generators 104 from inclement weather and/or spray from the stream or river, as well as the constant water flow from the river current 108. In addition, the housing or covering 302 is useful for protecting the generators 104 from vandalism or other unauthorized access. The housing or covering 302 may be made from fiberglass, aluminum, or other thermoplastic resins or metals. The housing or covering 302 may be attached directly to the flat deck 120 using any suitable attachment means, not shown. In alternate embodiments, the housing or covering 302 may be hingedly attached to the generator 104 or to the flat deck 120. One or more suitable locks, not shown, may be provided to prevent unauthorized removal of the housing or covering 302 from the generator 104 or from the flat deck 120 of the top surface 110.

In another embodiment, the river barge 102 can comprise legs 304 provided, typically around the periphery of the bottom surface 112. The legs 304 have a minimum length extending below the barge 102 and also corresponding to the radius of the multiple paddle wheels 106 projecting beneath the top surface 110 of the barge 102. The legs 304 have several functions, notably to prevent the bottoming of the paddle wheels 106 during periods of low water. In addition, the legs 304 are potentially useful during the construction of device 100 and/or for dry docking the device 100 during winter months. Legs 304 may be rigidly or slidably and adjustably attached to the bottom surface 112 of the barge 102 using mounting or height-adjusting mechanisms known to those skilled in the art. Typically, at least four legs 304 are provided. Legs 304 are typically disposed near the four corners of the bottom surface 112 of the barge 102. It will be recognized that other numbers of legs 304 may be chosen to meet a particular operating circumstance or environment. Consequently, the invention is not considered limited to any particular number, style, attachment point, or attachment modality of legs 304 but covers any number of legs 304 attached to the barge 102 in any manner.

In one embodiment, if the river paddle wheel generator device 100 is to be used in navigable waters, it is imperative that appropriate navigational lights 306 be provided in accordance with United States Coast Guard regulations, local regulations, or any other authority having such a requirement. Lights 306 may be disposed on masts or directly attached to the flat deck 120, as required, or to the paddle wheels 106, etc. The selection and placement of navigational lights 306 for watercraft is well known to those of skill in the art and is not further described herein.

In another embodiment, there are three river paddle wheel generator devices 100 supported on three floating barges 102 that are spaced from each other across the width of the riverbed. The spacing of the barges 102 creates channels that enhance the flow of water flowing therebetween, and thus the paddle wheels 106 turn with greater rapidity because of the increased flow velocity of the water. Typically, the barges 102 are anchored into the riverbed or tethered to posts or stanchions on the riverbanks by flexible cables. The flexible cables allow the floating barges 102 some slack to accommodate changing river levels and changing river currents 108. The multiple generators 104 are in communication to accumulate electricity for distribution to the electrical grid system or stored in batteries. Any suitable number of river paddle wheel generator devices 100 can be utilized together to generate electricity. For example, electrical companies can utilize several of these barges 102 to generate renewable energy for their customers.

As shown in FIG. 4, in operation, the river paddle wheel generator device 100 may be constructed in a dry dock where the legs 306 elevate the multiple paddle wheels 106 above a deck or other surface. When desired, the device 100 may be placed into a flowing body of water and navigated to a desired location thereupon by a pusher boat or pulled by a tugboat, which is attached to the barge 102 at mooring attachment points 200.

Once in position, cables, rods or ropes 202, or the like may be used to tether/anchor the device 100 in the river or stream. Specifically, anchor blocks 204 are typically used for mooring the barge 102 in the riverbed for use. Further, mooring attachment points 200 are typically provided at or near the outer corners of the flat deck 120 to allow a two-point anchoring system to be used thereby optimizing alignment of the barge 102 with the water current 108.

Furthermore, the multiple paddle wheels 106 extend beneath the top surface 110 of the barge 102 and are rotated by the action of water against the blades 128 thereof. The rotation of the paddle wheels 106 turns the power take off device 124 (i.e., a pulley or bull gear). Then, rotary motion of the power take off 124 is transferred to an input of the transmission or gearbox 130 by belts. The output of the transmission or gearbox 130 is, likewise, coupled to the generator 104 by a belt. Further, the transmission or gearbox 130 is then used to manually, semi-automatically, or fully automatically control the rotational speed of the generator 104 as water current 108 conditions in the stream or river change. Such control of the transmission or gearbox 130 is well understood by those of skill in the art; a more complete description of the operation thereof is not included herein. As previously stated, the transmission or gearbox 130 may be a gearless transmission using one or more conical pulleys to maintain a substantially constant speed of the generator 104 regardless of the rotational speed of the paddle wheels 106. Electrical power produced from the generator 104 may be used to charge an on-vessel battery or batteries (not shown) to power navigational lights 306, etc. A step-up transformer, not shown, may raise the generator voltage to minimize transmission losses to shore. Further, power transmission to shore may be by an underwater or an overhead cable, not shown. In another embodiment, an electrical main or cable 400 extends outwardly through the central shaft 122 and from the generator 104 for interconnection to the existing electrical grid system in the region or locale for which the river paddle wheel generator device 100 has been set up so that electricity is continuously supplied to the grid system.

As shown in FIG. 5, in one embodiment, the barge 102 is manufactured from steel, aluminum, plastic, fiber-reinforced plastic, or other suitable materials as is known in the art, or a combination of such materials.

In yet another embodiment, the river paddle wheel generator device 100 comprises a plurality of indicia 500. The river barge 102 of the device 100 may include advertising, a trademark, or other letters, designs, or characters, printed, painted, stamped, or integrated into the river barge 102, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be riverbed, water, or brand related.

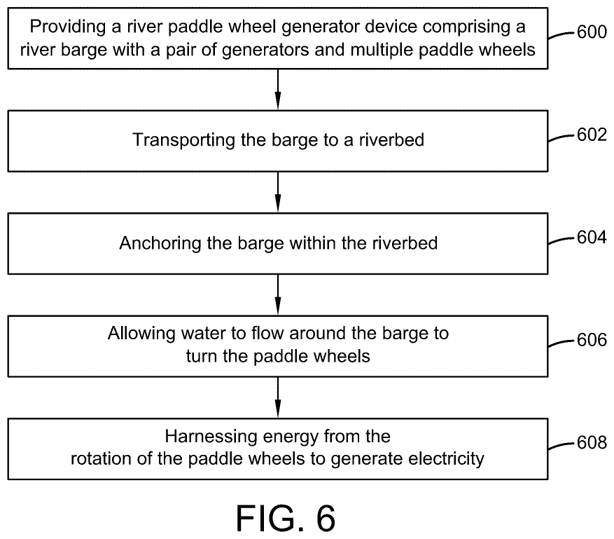

FIG. 6 illustrates a flowchart of the method of generating energy via river currents. The method includes the steps of at 600, providing a river paddle wheel generator device comprising a river barge with multiple generators and multiple paddle wheels. The method also comprises at 602, transporting the barge to a riverbed. Further, the method comprises at 604, anchoring the barge within the riverbed. The method also comprises at 606, allowing water to flow around the barge to turn the paddle wheels. Finally, the method comprises at 608, harnessing energy from the rotation of the paddle wheels to generate electricity.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “river paddle wheel generator device”, “river paddle wheel device”, “generator”, and “device” are interchangeable and refer to the river paddle wheel generator device 100 of the present invention.

Notwithstanding the foregoing, the river paddle wheel generator device 100 of the present invention can be of any suitable size and configuration as is known in the art without affecting the overall concept of the invention, provided that it accomplishes the above-stated objectives. One of ordinary skill in the art will appreciate that the river paddle wheel generator device 100 as shown in FIGS. 1-6 is for illustrative purposes only, and that many other sizes and shapes of the river paddle wheel generator device 100 are well within the scope of the present disclosure. Although the dimensions of the river paddle wheel generator device 100 are important design parameters for user convenience, the river paddle wheel generator device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A river paddle wheel generator device that provides a user with a means for generating electricity via a river's current, the river paddle wheel generator device comprising:
a river barge;
a plurality of paddle wheels;
a generator;
an electrical cable for electricity transmission from the generator;
a lockable thermoplastic resin generator covering attached to a deck of the river barge; and
a plurality of mooring attachment points each comprising a mooring cable and an anchor block; and
wherein the river barge is anchored within a riverbed of moving water via the anchor blocks;
wherein the generator is positioned on the river barge;
wherein the multiple paddle wheels are positioned on opposing sides of the generator and are positioned such that the multiple paddle wheels contact the moving water; and
wherein the moving water rotates the multiple paddle wheels which then turns the generator and creates renewable electricity.

2. (canceled)

3. The river paddle wheel generator device of claim 1, wherein the river barge comprises a top surface, a bottom surface, a bow and a stern sides, and opposing sidewalls.

4. The river paddle wheel generator device of claim 3, wherein the top surface comprises a flat deck for easy transport of the generator and the multiple paddle wheels.

5. The river paddle wheel generator device of claim 4, wherein the river barge comprises multiple paddle wheels.

6. (canceled)

7. (canceled)

8. (canceled)

9. (canceled)

10. (canceled)

11. (canceled)

12. (canceled)

13. (canceled)

14. A river paddle wheel generator device that provides a user with a means for generating electricity via a river's current, the river paddle wheel generator device comprising:
a river barge comprising a top surface, a bottom surface, a bow side and a stern side, and opposing sidewalls;
a plurality of paddle wheels supported on a central shaft, which is supported by bearings;
a generator comprising a covering attached to the river barge to protect the generator from inclement weather and from constant water flow from river current;
an electrical cable extending out of the central shaft for electricity transmission from the generator; and
a plurality of mooring attachment points each comprising a mooring cable and an anchor block; and
wherein the top surface comprises a flat deck for easy transport of the generator and multiple paddle wheels positioned on top;
wherein the multiple paddle wheels are positioned on opposing sides of the generator and are positioned such that the multiple paddle wheels contact the moving water;
wherein the moving water rotates the multiple paddle wheels which then turns the generator and creates the renewable electricity; and
wherein the river barge further comprises a plurality of height-adjustable legs slidably attached to the bottom surface of the river barge.

15. The river paddle wheel generator device of claim 14 further comprising a debris guard to prevent water-borne debris from jamming or injuring the multiple paddle wheels.

16. (canceled)

17. The river paddle wheel generator device of claim 14 further comprising multiple lights on the river barge for safety.

18. The river paddle wheel generator device of claim 14 wherein the river barge is manufactured of steel.

19. The river paddle wheel generator device of claim 14 further comprising a plurality of indicia.

20. (canceled)
